(19) United States
(12) Patent Application Publication
(10) Pub. No.: US 2007/0261537 A1
(43) Pub. Date: Nov. 15, 2007

(54) CREATING AND SHARING VARIATIONS OF A MUSIC FILE

(75) Inventors: Antti Eronen, Tampere (FI); Timo Kosonen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/382,970

(22) Filed: May 12, 2006

(51) Int. Cl. G10H 1/40; G10H 7/00

(52) U.S. Cl. 84/611

(57) ABSTRACT

A method, device, system and apparatus are provided for creating and sharing variations of a music file, wherein a variation metadata file is created that indicates which beats, measures and/or segments of an original music file are included in the variation created, in what order these beats, measures and/or segments have been combined, how many times each is looped, and the like. In particular, the variation metadata file may include a combination of indices associated with respective beats, measures and/or segments of the variation, wherein the indices have been listed or otherwise combined in the order and combination in which the various beats, measures and/or segments of the corresponding variation have been combined. As a result, the variation metadata file includes a relatively limited amount of data that can subsequently be transmitted and/or used to recreate the variation or remix.

### FIELD

Exemplary embodiments of the present invention relate, generally, to creating variations of a music file and, in particular, to a technique for sharing the variations created.

### BACKGROUND

In general, musical works are typically composed of a melody, harmony, dynamics and rhythm, and it is based on these characteristics that a musical work is often perceived and analyzed. Music rhythm is the organization of a musical work in relation to time. In particular, the rhythm consists of various pulse sensations occurring at different time scales or levels. The most prominent time scale or level of pulse sensations is the foot tapping rate, also referred to as the tactus or beat. As used herein, the term “beat” is used to refer to the individual elements that make up a given pulse.

The next time scale or level of pulse sensations is the bar or musical measure. In general, a bar or musical measure pulse relates to the harmonic change rate or the length of a rhythmic pattern. In music notations, these rhythmic patterns (i.e., measures or bars) are separated by bar lines. Typically, every Nth beat of the tactus pulse coincides with a beat of the measure pulse (i.e., measures can typically be divided into N beats, where N is some fixed integer value greater than one).

A fair amount of research interest has been directed towards analyzing the basic pattern of beats in a piece of music (i.e., the musical meter) and towards automatically tracking the beats of a sampled musical work. In particular, research has been performed to study the estimations of a music measure and to develop a measure or bar line estimator. See e.g., Klapuri, Anssi P, et al.: Analysis of the Meter of Acoustic Musical Signals, IEEE Transactions on Audio, Speech and Language Processing, Vol. 14, No. 1, pp. 342-355, January 2006 (referred to hereinafter as “Klapuri et al.”), the contents of which are hereby incorporated herein by reference.

Many musical pieces, especially those from the pop music category, have a distinguishable segment structure, where the different segments may repeat. Typical sections in music include, for example, the intro, verse, bridge, chorus, and outro. A typical repeating structure of a pop music file may be, for example, “intro, verse, chorus, verse, chorus, chorus.” Research has been done to detect the choruses and other repeating sections in music. See e,g,, Masataka Goto: A Chorus-Section Detecting Method for Musical Audio Signals, ICASSP 2003 (The 2003 IEEE International Conference on Acoustics, Speech, and Signal Processing) Proceedings, pp. V-437,440, April 2003. (referred to hereinafter as “Goto”), the contents of which are hereby incorporated herein by reference.

In a typical music player, a user is able to play, stop, pause, fast forward and rewind a musical work, as well as skip to a next or previous track of a musical collection. With most conventional fast forward and rewind functionalities, the user is able to move fast within the musical work or track, but because no attention is paid to the basic beat pattern of the work while doing so, the continuity and musically pleasing aspects of the musical work are often sacrificed. In addition, using a standard music player, there is typically no way to alter the length of a musical work (i.e., shorten or lengthen the musical work) absent cutting the work off prior to its completion or simply playing the musical work back again.

A need, therefore, exists, for a technique for implementing typical music player functionality (e.g., playing, pausing, fast forwarding and rewinding a musical work) in a manner that allows the musical work to remain musically pleasing, as well as provides increased functionality (e.g., enabling a user to shorten and/or lengthen the duration of the musical work).

Using a disc jockey (“DJ”) device or audio editor, a user may be able to rearrange and loop sections of a musical work in the desired manner discussed above. In particular, the user may be able to segment the musical work and thereafter rearrange the segments or sections or set a particular section to loop a predetermined amount of times. This may be possible even in real-time, such that the DJ is able to change the playback order of a music segments during a live performance. In general, however, the user interface of these devices is rather complicated for the amateur listener. For example, in order for the resulting musical work (i.e., the result of the user's segmenting, rearranging and looping) to remain continuous, the user him/herself may be required to segment the musical work according to the beats, measures or segments (e.g., intro, verse, chorus, bridge and outro) of the musical work. In other words, the user may be required to accurately estimate the beats, bars or measures, and then cause the musical work to be segmented at an appropriate time between respective beats, bars or measures. This may be difficult for someone perhaps lacking patience, a particularly musical ear, or the appropriate training. In addition, availability of the foregoing functionality in portable devices (e.g., cellular telephones, personal digital assistants (PDAs), pagers, and the like) is currently rather limited.

A further need, therefore, exists for a user interface that enables even an amateur to perform the above-described functionality with skill. In addition, a need exists for such a user-friendly user interface that can be used in connection with a user's mobile or portable device.

In addition to the foregoing, it is often desirable for an individual to be able to share the variations or remixes he or she has created with others. However, at least two issues arise when a user attempts to do so. The first is the fact that the original music file is usually copyright protected and, therefore, cannot legally be transmitted to another individual. In order to legally share variations of a copyright protected work, therefore, a need exists for a technique for so sharing that does not require any part of the original work to be transmitted.

The second issue relates to the size of most files associated with a variation or remix. Typically the remix or variation is at least as large as the original musical work or file, since it often includes more segments of the musical work than the original. Sharing the variation or remix with others can, therefore, become rather cumbersome. A further need, therefore, exists for a way in which to share variations or remixes of an original musical work that reduces the amount of data that must be transmitted.

### BRIEF SUMMARY

In general, exemplary embodiments of the present invention provide an improvement over the known prior art by, among other things, providing a method, device, system and apparatus for creating and sharing variations of a music file, wherein a variation metadata file is created that includes a relatively limited amount of data, none of which includes any portion of the original musical work, and that can be subsequently stored, transmitted and used in order to recreate the variation or remix of the original musical work. In particular, according to exemplary embodiments of the present invention, as a user skips, repeats and/or loops various beats, measures and/or segments of a musical work, the beats, measures and/or segments actually played are recorded. An index can then be associated with each beat, measure and/or segment recorded, and a variation metadata file may be created based on a combination of these indices. The order and manner in which the indices are combined in the variation metadata file is reflective of the order and manner in which the various beats, measures and/or segments were played when creating the variation. In order to use the variation metadata file to later recreate the variation, a rhythm metadata file including both an index associated with each beat, measure and segment of the original musical work, as well as an indication of a location within the musical work associated with each beat, measure and segment, is accessed in order to determine the location within the original musical work of the beats, measures and/or segments of the variation, as indicated by the indices of the variation metadata file.

In accordance with one aspect, a method is provided of creating and sharing one or more variations of a music file. In one exemplary embodiment, the method includes: (1) enabling a user to create a variation of a music file, wherein the music file comprises one or more segments, respective segments further comprise one or more measures and respective measures further comprise one or more beats, and wherein the variation includes a combination of at least one of the beats, measures or segments of the music file; and (2) creating a variation metadata file that includes an index associated with respective at least one beat, measure or segment of the combination and indicates an order in which the at least one beat, measure or segment are combined, wherein the variation metadata file is capable of being stored and transmitted separately from the music file.

In one exemplary embodiment, the method further includes analyzing the music file to determine a location within the music file corresponding with respective beats, measures and segments of the music file; assigning an index to respective beats, measures and segments; and creating a rhythm metadata file associated with the music file, wherein the rhythm metadata file includes a combination of the assigned index and an indication of the determined location within the music file corresponding with respective beats, measures and segments of the music file. The indication of the determined location within the music file corresponding with respective beats, measures and segments may, in one exemplary embodiment, include some combination of a time associated with a beginning of respective beats, measures and segments, a time associated with an end of respective beats, measures and segments, a number of beats per measure, and a number of measures per segment.

In another exemplary embodiment, the method further includes playing the music file. In this exemplary embodiment, enabling a user to create a variation of the music file comprises enabling the user to vary at least one of the beats, measures or segments of the music file currently playing, such that playing the music file comprises playing the music file as varied. The method of this exemplary embodiment may further include recording at least one beat, measure or segment played; determining an index associated with respective at least one beat, measure or segment recorded, based at least in part on the rhythm metadata file associated with the music file; and combining the at least one index into the variation metadata file, such that the combination of indices reflects the at least one beat, measure or segment played and an order in which the at least one beat, measure or segment were played.

In accordance with another aspect, a user interface is provided for creating one or more variations of a music file. In one exemplary embodiment, the user interface includes a plurality of input elements, wherein respective input elements are configured to receive at least one of a plurality of commands for varying a music file that includes one or more segments, respective segments include one or more measures and respective measures include one or more beats. The user interface of this exemplary embodiment further includes an output element configured to output a variation of the music file in response to the at least one command, such that the variation comprises one or more beats, measures and segments of the music file that have been varied based at least in part on a location within the music file associated with at least one beat, measure or segment of the music file.

In one exemplary embodiment, at least one of the plurality of input elements includes a repeat element configured to receive a command to repeat at least one beat, measure or segment of the music file, and the output element is configured to repeat the at least one beat, measure or segment based at least in part on a location associated with a beginning of the at least one beat, measure or segment. In another exemplary embodiment, at least one of the plurality of input elements includes a skip forward element configured to receive a command to skip forward at least one beat, measure or segment of the music file. The output element of this exemplary embodiment, in turn, is configured to output a current beat of the music file prior to outputting a next beat, measure or segment, as determined based at least in part on a location within the music file associated with a beginning of the next beat, measure or segment. In yet another exemplary embodiment, at least one of the plurality of input elements includes a skip back element configured to receive a command to skip back at least one beat, measure or segment of the music file. The output element of this exemplary embodiment, in turn, is configured to output a current beat of the music file prior to outputting a previous beat, measure or segment, as determined based at least in part on a location within the music file associated with a beginning of the previous beat, measure or segment

According to yet another aspect, an apparatus is provided for creating and sharing one or more variations of a music file. In one exemplary embodiment the apparatus includes a processing element configured to: (1) record a combination of one or more beats, measures and segments of a music file in an order and a combination in which the beats, measures and segments are currently being played; (2) determine an index associated with respective beats, measures and segments of the combination; and (3) create a variation metadata file that includes the associated indices determined, wherein the indices are combined in the order and combination in which the corresponding beats, measures and segments were played.

According to another aspect, an apparatus for recreating one or more variations of a music file is provided. In one exemplary embodiment the apparatus includes a processing element configured to: (1) receive a variation metadata file comprising one or more indices associated with a respective one or more beats, measures or segments of a variation of a music file; (2) access a rhythm metadata file comprising a combination of one or more indices associated with a respective one or more beats, measures and segments of the music file and an indication of a location within the music file associated with respective beats, measures and segments of the music file; and (3) determine, based at least in part on the variation metadata file and the rhythm metadata file, a location within the music file corresponding with respective beats, measures and segments of the variation of the music file.

In accordance with another aspect, a device is provided that is capable of creating and sharing one or more variations of a music file. In one exemplary embodiment, the device includes: (1) a processor; (2) a user interface configured to enable a user to create a variation of a music file, wherein the music file includes one or more segments, respective segments comprise one or more measures and respective measures comprise one or more beats, and wherein the variation includes a combination of at least one of the beats, measures or segments of the music file; and (3) a memory in communication with the processor, wherein the memory stores an application executable by the processor, and wherein the application is configured, upon execution, to create a variation metadata file that comprises an index associated with respective at least one beat, measure or segment of the combination and indicates an order in which the at least one beat, measure or segment are combined. In one exemplary embodiment, the variation metadata file is capable of being stored and transmitted separately from the music file and further of being used to recreate the variation of the music file.

In accordance with another aspect, a system is provided for creating and sharing one or more variations of a music file. In one exemplary embodiment, the system includes a first and second device, wherein the first device is configured to: (1) enable a user to create a variation of a music file, wherein the music file includes one or more segments, respective segments further comprise one or more measures, and respective measures further comprise one or more beats, and wherein the variation includes a combination of at least one of the beats, measures or segments of the music file; (2) create a variation metadata file that includes an index associated with respective at least one beat, measure or segment of the combination and an indication of an order in which the at least one beat, measure or segment are combined; and (3) separately transmit the variation metadata file. In one exemplary embodiment, the second device is configured to receive the variation metadata file and to recreate the variation of the music file using the variation metadata file received.

In accordance with yet another aspect, a computer program product is provided for creating and sharing one or more variations of a music file. The computer program product contains at least one computer-readable storage medium having computer-readable program code portions stored therein. The computer-readable program code portions of one exemplary embodiment include: (1) a first executable portion for enabling a user to create a variation of a music file, wherein the music file comprises one or more segments, respective segments include one or more measures, and respective measures further include one or more beats, and wherein the variation includes a combination of at least one of the beats, measures or segments of the music file; and (2) a second executable portion for creating a variation metadata file that includes an index associated with respective at least one beat, measure or segment of the combination and indicates an order in which the at least one beat, measure or segment are combined, wherein the variation metadata file is capable of being stored and transmitted separately from the music file and further of being used to recreate the variation of the music file.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a flow chart illustrating the steps which may be taken in order to create and share one or more variations of a music file in accordance with exemplary embodiments of the present invention;

FIG. 2 is a flow chart illustrating the steps which may be taken in order to create a rhythm metadata file associated with a music file in accordance with exemplary embodiments of the present invention;

FIG. 3 is a flow chart illustrating the steps which may be taken in order to create a variation of a currently playing music file in accordance with exemplary embodiments of the present invention;

FIGS. 4A and 4B illustrate a user interface which may be used in order to create the variation of the currently playing music file in accordance with exemplary embodiments of the present invention;

FIG. 5 illustrates a method of transitioning using crossfading in accordance with an exemplary embodiment of the present invention;

FIG. 6 is a flow chart illustrating the steps which may be taken in order to create a variation metadata file associated with the variation created in accordance with exemplary embodiments of the present invention;

FIG. 7 is a flow chart illustrating the steps which may be taken in order to recreate the variation of the music file in accordance with exemplary embodiments of the present invention;

FIG. 8 is a block diagram of one type of system that would benefit from exemplary embodiments of the present invention; and

FIG. 9 is a schematic block diagram of an electronic device capable of operating in accordance with an exemplary embodiment of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a technique for creating and sharing variations of a music file that is easy to use and does not require that any copyrights in the original work be violated. In particular, according to exemplary embodiments, a user is capable of manipulating or varying one or more beats, measures or segments of a musical work while the musical work is being played. The user is further able to do so in a manner that relies on annotated rhythmic information associated with the musical work to ensure that the variation or remix remains continuous and pleasing to the listener. In one exemplary embodiment, the rhythmic information relied on includes, for example, locations within the musical work associated with each beat, measure and segment of the musical work, as well as a corresponding indices for each beat, measure and segment.

In addition, the user is able to capture, as metadata, the resulting combination of beats, measures and/or segments of the variation in a format that is condense and easily transmitted. In particular, according to exemplary embodiments, a variation metadata file is created that includes merely a list of indices associated with respective beats, measures and/or segments of the variation created in an order and combination that is representative of the corresponding variation. Using the rhythmic information associated with the original musical work, the user, or some other party to whom the user has transmitted the variation metadata file, may recreate the variation by, for example, cross-referencing the indices of the variation metadata file with the indices and locations of the rhythmic metadata file.

Exemplary embodiments of the present invention are, therefore, advantageous at least because they enable a user to easily create variations of a musical work that maintain the rhythmic integrity of the original work. Exemplary embodiments further enable users to share these variations without having to transmit any portion of the original musical work and, therefore, potentially violate copyrights in the original work. A further advantage is that the amount of information that must be transmitted in order to share the variation is further reduced by the fact that the user need not transmit any timing information (e.g., specific beat, measure, segment or loop times) associated with the variation, since the user can assume that the recipient either possesses, or is capable of accessing, such information separately (i.e., in the form of the rhythm metadata file).

Method of Creating and Sharing Variations of a Music File

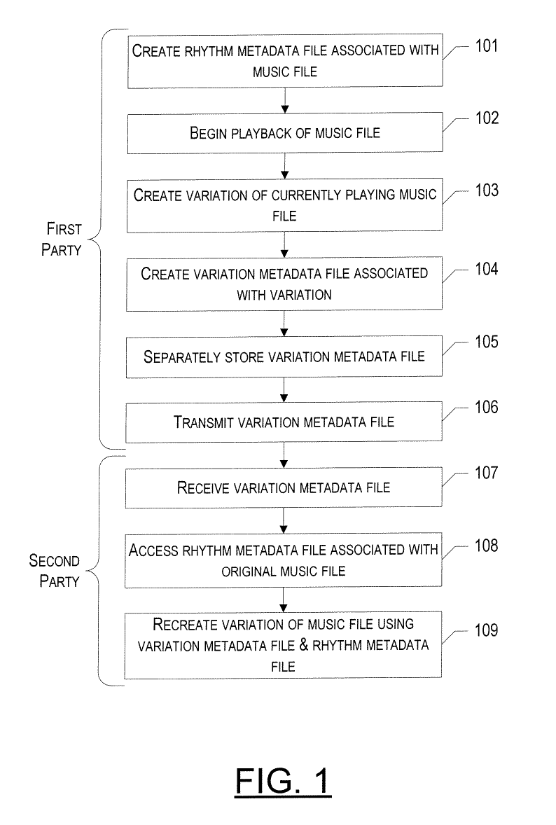

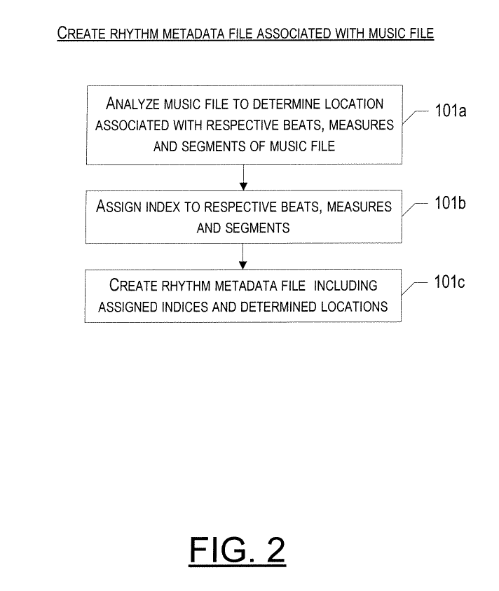

Reference is now made to FIG. 1, which illustrates the steps which may be taken in order to create and share one or more variations of a music file in accordance with exemplary embodiments of the present invention. As shown, the process begins at Step 101 where a rhythm metadata file associated with a particular musical work or file is created. In general, a rhythm metadata file is a file that stores beat and measure information relating to a particular music file as metadata along with the corresponding music file. The beat or measure information may, for example, have been annotated by experts or automatically analyzed using a meter estimator, such as the one described in Klapuri et al. In particular, reference is made to FIG. 2, which illustrates the steps which may be taken in order to create the rhythm metadata file according to exemplary embodiments of the present invention.

In a first step (Step 101a), the music file is analyzed to determine a location associated with respective beats, measures and segments of the music file. As discussed above, a music file comprises a plurality of beats (or tactus pulses), one or more measures, which each typically comprise a combination of one or more beats forming a rhythmic pattern, and one or more segments, defined as sections longer than one measure and including, for example, the intro, verse, chorus, bridge and outro. Determining the location associated with respective beats, measures and segments may involve determining the beginning time of each beat, measure and segment (i.e., the amount of time from the beginning of the music file to the start of each beat, measure and segment), as well as the ending time of each beat, measure and segment. Alternatively, only the beginning time may be determined, as well as, for example, the number of beats per measure and/or the number of measures per segment.

The choruses and other sections of the music file can be annotated by experts or analyzed automatically using, for example, the method described in Goto. The method in Goto may return only repeating sections of the music file, but the remaining sections not explained by the method of Goto can be assigned as their own sections. The section boundaries returned by the method of Goto do not necessarily coincide with the times of measures or beats, and thus the boundaries can be rounded to the nearest beat or measure. If there is overlap in the sections returned by the method of Goto, then these overlapping sections can be combined into longer sections that do not overlap.

Once the location of each beat, measure and segment has been determined, in Step 101b, an index may further be assigned to each. Indices may include, for example, B1, B2 . . . BQ, for each Q non-overlapping beats of the music file, M1, M2 . . . MP, for each of P non-overlapping measures of the music file, S1, S2 . . . SN, for each N non-overlapping segments of the music file and C1, C2 . . . CR, for each R choruses of the music file, wherein Q, P, N and R are positive integers greater than or equal to one. Alternatively, pulses of a smaller time scale or level may be represented as decimal or fractional values of the pulses of a larger time scale or level. For example, beats may be represented as decimal values of the various measures (e.g., M1.1, M1.2, M1.3 . . . M1.E, where M1.1 denotes the first beat of the first measure and M1.E denotes the last or end beat of the first measure). Measures may further be represented as decimal or fractional values of the various segments (e.g., S1.1, S1.2, S1.3 . . . S1.E, where S1.1 denotes the first measure of the first segment and S1.E denotes the last or end measure of the first segment). Beats, measures and segments may further be combined into a single index having two decimal points (e.g., S1.1.1, S1.1.2 . . . S1.1.E, S1.2.1 . . . S1.E.1 . . . S.1.E.E, wherein the first number represents the segment, the first decimal value represents the measure, and the second decimal value represents the beat).

To further illustrate, the following Table 1 provides an example of how the beats and measures of a particular music file may be annotated in accordance with exemplary embodiments of the present invention. As shown, the music file has four beats per measure corresponding to, for example, a 4/4 signature where each measure consists of four quarter notes, wherein B denotes a beat and M denotes the first beat of a measure.

TABLE 1

| | | | | | | | | | | | | | |
|---|---|---|---|---|---|---|---|---|---|---|---|---|---|
| . . . | M | B | B | B | M | B | B | B | M | B | B | B | . . . |

Table 2 below provides a further example of a segment structure of a musical work. As shown, in this example, the fourth segment S4 coincides with the first chorus C1 of the music file, while the seventh segment S7 coincides with the second chorus C2.

TABLE 2

| | | | | | | | |
|---|---|---|---|---|---|---|---|
| . . . | S3 | S4/C1 | S5 | S6 | S7/C2 | S8 | . . . |

As one of ordinary skill in the art will recognize, the foregoing is just one example of how indices may be assigned to the various beats, measures and/or segments of a music file. Other techniques and indices may similarly be used without departing from the spirit and scope of the present invention. For example, another metrical level may be added below the beat, such that each beat would be divided into a number of tatums, or temporal atoms, typically corresponding to ⅛^{th} or 1/16^{th} notes. In this exemplary embodiment, the indices or representations would have another level, such that S1.1.1.1 would denote the first tatum of the first beat of the first measure of the first segment. As another example, it may be possible to implement exemplary embodiments of the present invention in terms of beats and measures only, thus eliminating the designation of segments, or as beats and segments only, thus eliminating the designation of measures. As is thus illustrated, many similar conventions may likewise be used in order to annotate the beats and rhythmic pattern of a musical work without departing from the spirit and scope of the present invention.

Returning to FIG. 2, in Step 101c, the rhythm metadata file is created including both the assigned indices for each beat, measure and segment and an indication of the determined location of each (e.g., some combination of the beginning and ending times, the number of beats per measure, and the number of measures per segment). In one exemplary embodiment, the rhythm metadata file may comprise a simple text file of the form shown below.

<S 1>

<number_of_measures>4</number_of_measures>
<M 1>

<number_of_beats>4</number_of_beats>
<B 1>

<start_time>0.03</start_time>

</B 1>
<B 2>

<start_time>0.63</start_time>

</B 2>
<B 3>

<start_time>1.23</start_time>

</B 3>
<B 4>

<start_time>1.83</start_time>

</B 4>

</M 1>
<M 2>

<number_of_beats>4</number_of_beats>
<B 1>

<start_time>2.0122</start_time>

</B 1>
<B 2>

<start_time>2.6282</start_time>

</B 2>
<B 3>

<start_time>3.2522</start_time>

</B 3>
<B 4>

<start_time>3.8682</start_time>

</B 4>

</M 2>
<M 3>

<number_of_beats>4</number_of_beats>
<B 1>

<start_time>4.4922</start_time>

</B 1>
<B 2>

<start_time>5.1002</start_time>

</B 2>
<B 3>

<start_time>5.7082</start_time>

</B 3>
<B 4>

<start_time>6.3402</start_time>

</B 4>

</M 3>
<M 4>

<number_of_beats>4</number_of_beats>
<B 1>

<start_time>6.9562</start_time>

</B 1>
<B 2>

<start_time>7.5642</start_time>

</B 2>
<B 3>

<start_time>8.1802</start_time>

</B 3>
<B 4>

<start_time>8.7962</start_time>

</B 4>

</M 4>

</S 1>
<S 2>

<number_of_measures>4</number_of_measures>
<M 1>

<number_of_beats>4</number_of_beats>
<B 1>

<start_time>9.4122</start_time>

</B 1>
<B 2>

<start_time>10.0202</start_time>

</B 2>
<B 3>

<start_time>10.6442</start_time>

</B 3>
<B 4>

<start_time>11.2602</start_time>

</B 4>

</M 1>
<M 2>

<number_of_beats>4</number_of_beats>
<B 1>

<start_time>11.8602</start_time>

</B 1>
<B 2>

<start_time>12.4602</start_time>

</B 2>
<B 3>

<start_time>13.0682</start_time>

</B 3>
<B 4>

<start_time>13.6842</start_time>

</B 4>

</M 2>
<M 3>

<number_of_beats>4</number_of_beats>
<B 1>

<start_time>14.2922</start_time>

</B 1>
<B 2>

<start_time>14.8922</start_time>

</B 2>
<B 3>

<start_time>15.4922</start_time>

</B 3>
<B 4>

<start_time>16.1002</start_time>

</B 4>

</M 3>
<M 4>

<number_of_beats>4</number_of_beats>
<B 1>

<start_time>16.7002</start_time>

</B 1>
<B 2>

<start_time>17.3242</start_time>

</B 2>
<B 3>

<start_time>17.9162</start_time>

</B 3>
<B 4>

<start_time>18.5242</start_time>

</B 4>

</M 4>

</S 2>
<S 3>

<number_of_measures>6</number_of_measures>
<M 1>

<number_of_beats>4</number_of_beats>
<beat_interval>0.6000</beat_interval>
<B 1>

<start_time>19.1402</start_time>

</B 1>

</M 1>
<M 2>

<number_of_beats>4</number_of_beats>
<beat_interval>0.6000</beat_interval>
<B 1>

<start_time>21.5402</start_time>

</B 1>

</M 2>
<M 3>

<number_of_beats>4</number_of_beats>
<beat_interval>0.6000</beat_interval>
<B 1>

<start_time>23.9402</start_time>

</B 1>

</M 3>
<M 4>

<number_of_beats>4</number_of_beats>
<beat_interval>0.6000</beat_interval>
<B 1>

<start_time>26.3402</start_time>

</B 1>

</M 4>
<M 5>

<number_of_beats>4</number_of_beats>
<beat_interval>0.6000</beat_interval>
<B 1>

<start_time>28.7402</start_time>

</B 1>

</M 5>
<M 6>

<number_of_beats>4</number_of_beats>
<beat_interval>0.6000</beat_interval>
<B 1>

<start_time>31.1402</start_time>

</B 1>

</M 6>

</S 3>
<C 1>

<S 3>

</C 1>

The example above illustrates a rhythm metadata file corresponding with a musical excerpt whose length is 33.5 seconds. The excerpt consists of three sections (S1, S2 and S3), wherein the third section (S3) corresponds with the first chorus (C1). The first two sections (S1 and S2) each consists of four measures, while the third section (S3) consists of six measures. Each measure is further divided into four beats. The first two sections (S1 and S2) indicate the start times of each beat, while the third section (S3) indicates only the start time of the first beat in conjunction with the time interval between beats. The beat interval indicates the time difference, in seconds, between the start times of two successive beats. The times of individual beats within each measure can then be calculated based on the time of the first beat, the beat interval, and the number of beats per measure. For example, the beat start times for the sixth measure (M6) of section three (S3) can be calculated as 31.1402, 31.7402, 32.3402, 32.9402 seconds, since, as indicated in the exemplary rhythm metadata file shown above, there are four beats in the sixth measure, the beat interval is 0.6000 seconds, and the start time of the first beat is 31.1402 seconds. The beat ending times are not separately indicated in the above example, since a beat ends just before the next beat starts and, therefore, can be easily ascertained. The ending time of a measure can be taken as the ending time of its last beat. A measure ends just before the beginning of the first beat in the next measure. In the example shown above, the section C1 (i.e., the first chorus) does not have its own measure and beat annotations, but rather just refers to section three (S3).

In one exemplary embodiment, the foregoing steps of FIG. 2 are performed by a user's electronic device upon downloading or receiving a particular music file. Alternatively, in another exemplary embodiment, the entity responsible for providing the music file (e.g., an online retail supplier) may have created the rhythm metadata file and associated it with the music file prior to providing it to the user.

The overall process illustrated in FIG. 1 continues, in Steps 102, where the user first begins playback of the music file, of which he or she desires to create a variation or remix. Thereafter, in Step 103, the user creates the variation of the music file while the music file is currently being played (i.e., in real time). In particular, according to exemplary embodiments of the present invention, the user is able to manipulate or vary the beats, measures or segments of the currently playing music file in a manner that does not disrupt the continuity or pleasing rhythm of the music file.

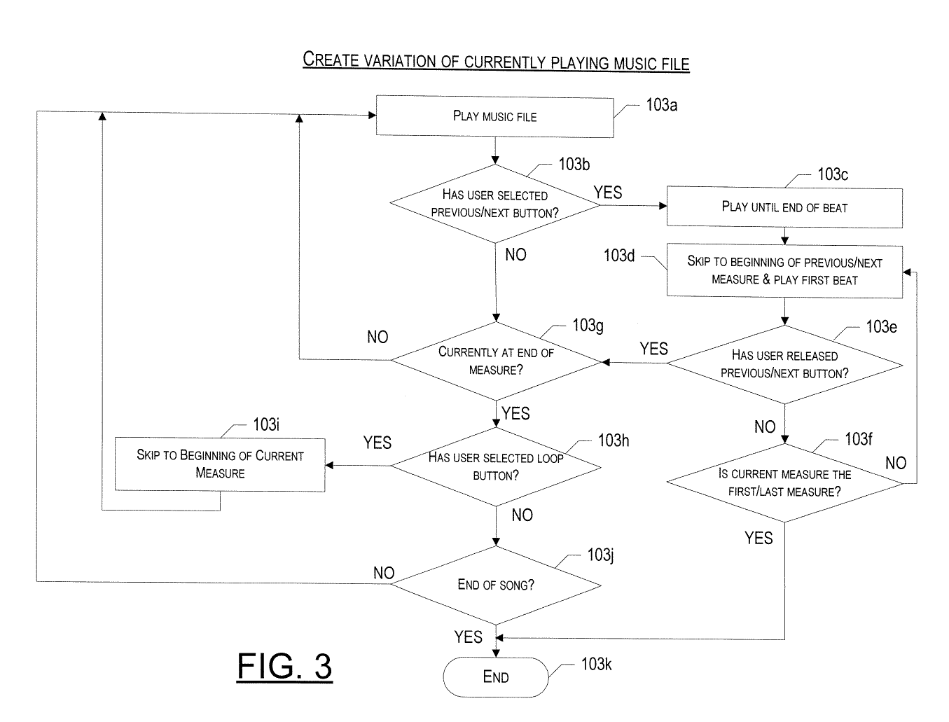

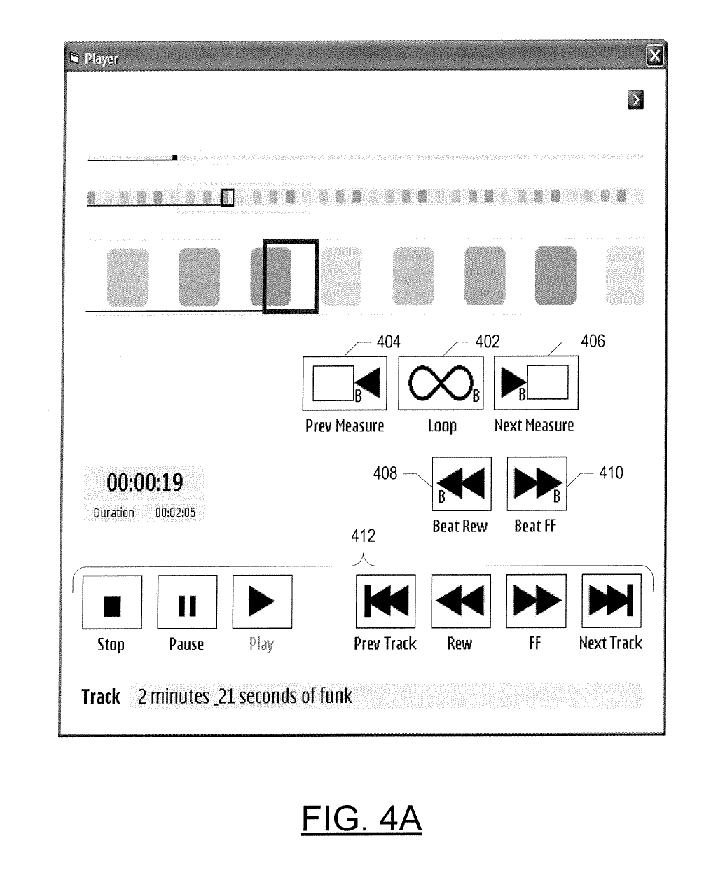

The steps which may be taken by the user in order to so manipulate the beats, measures or segments are shown in FIG. 3. In addition, FIGS. 4A and 4B provide exemplary user interfaces which may be used by the user in order to vary or manipulate the beats, measures or segments in the manner illustrated in FIG. 3. In one exemplary embodiment, the user interfaces of FIGS. 4A and 4B comprise a plurality of input elements, wherein respective input elements are configured to receive a command from a user to vary the music file in some manner. The user interface may further include an output element, such as a speaker, that is configured to output a variation of the music file in response to receiving the commands via the plurality of input elements. In particular, the output element of one exemplary embodiment may output a variation of a music file where the beats, measures and/or segments of the original music file have been varied based on information in the rhythm metadata file associated with respective locations within the music file corresponding with the beats, measures and/or segments. In one exemplary embodiment, the input elements may comprise a.keypad associated with the mobile or portable device, wherein respective keys of the keypad are capable of being depressed, or otherwise actuated, in order to affect a particular variation of the music file. Alternatively, the user interfaces of FIGS. 4A and 4B may comprise display screens or touch screens similarly associated with the mobile device, wherein the input elements comprise icons or representations displayed on the touch screen, such that a user is able to touch the touch screen in the vicinity of each of the icons or representations using, for example, a pointer or stylus, in order to affect particular variations.

As shown, and as is discussed in more detail below, the user interface may include, for example, a loop input element (e.g., button or icon) 402, a previous measure input element 404, and a next measure input element 406. Additional input elements (e.g., buttons or icons) may include, for example, a beat fast forward input element 408, a beat rewind input element 410, as well as one or more standard input elements associated with a typical music player 412 (e.g., stop, pause, play, previous track, rewind, fast forward and next track). In one exemplary embodiment, shown in FIG. 4B, the user interface may resemble the user interface of a typical music player with the exception that the user interface of FIG. 4B includes a loop input element (e.g., button) 402 in addition to the standard play, pause, stop, rewind and fast forward buttons 412 of a typical music player. In this exemplary embodiment, by actuating (e.g., depressing) the loop button 402, the user may alter the mode of the other keys or icons of the user interface. For example, actuating the loop button 402 may cause the typical fast forward button to essentially become a skip to the next measure button or icon 406. In particular, when the user actuates the fast forward button 412/406 after the loop button 402 has been actuated, the music player may wait until the end of the current beat and then move directly to the beginning of the next measure, rather than abruptly skipping some predetermined distance (e.g., measured in seconds or milliseconds) forward in the musical work. The same may be true for the rewind button 412 (i.e., it may become a skip to the previous measure button or icon 404 upon actuating the loop button 402). In yet another exemplary embodiment, the default setting may be for the typical fast forward and rewind buttons 412 to perform as previous or next measure buttons 404, 406, respectively. In either case, the user interface of FIG. 4B enables a user to use his or her standard keypad or touch screen with only a few small variations.

Referring to FIG. 3, in Step 103a, a music player associated with the mobile or portable device begins by playing the music file in its original form. At any point while the music file is being played, the user may actuate a previous or next measure button 404, 406 in order to cause the music player to skip to the previous or next measure of the music file. In particular, as shown in FIG. 3, it is determined, in Step 103b, whether the user has actuated the previous or next measure button 404, 406. If the user has actuated the previous or next measure button 404, 406, the music player will continue playing the music file until the end of the current beat (Step 103c), wherein information regarding the currently playing beat may be maintained by the music player throughout the playing time. The music player then skips to the beginning of the previous or next measure and plays the first beat of that measure (Step 103d). Information regarding the location of the beginning of the next or previous measure may be obtained by consulting the previously created rhythm metadata file associated with the music file. By continuing to play the music file until the current beat has been completed and skipping to the previous or next measure, rather than randomly skipping back or ahead some distance or amount of time, exemplary embodiments of the present invention ensure that the basic rhythm of the music file is not disturbed, thus providing an improvement over the standard music players, which typically disregard the beats or rhythmic pattern of the music file. In addition, by playing the first beat of each measure, exemplary embodiments provide a quick way for users to locate a point of interest within a song.

After playing the first beat of the previous or next measure, in one exemplary embodiment, the mobile device will determine, in Step 103e, if the user has released the previous or next measure button 404, 406. If not, indicating that the user wishes to again skip to the previous or next measure, the device will first determine whether the current measure is the first (in this instance where the user has actuated the previous measure button 404) or the last (in the instance where he or she has actuated the next measure button 406) measure of the music file (Step 103f), and if so, end the music file (Step 103k), since there is no where left to skip. If not, the music player will again skip to the previous or next measure and play the first beat of that measure (i.e., the process will return to Step 103d).

Returning to Step 103b, if it is determined that the user has not selected the previous or next measure button 404, 406, it is next determined, in Step 103g, if the song or music file is currently at the end of a measure. In general, this may be determined by accessing the rhythm metadata file associated with the music file that was created in Step 101 of FIG. 1 to determine the locations of the various measures within the music file. If it is determined that the music file is not currently at the end of a measure, the process returns to Step 103a, where the music file continues to be played in its normal (i.e., original) format. In contrast, if it is determined that the music file is currently at the end of a measure, it is next determined, in Step 103h, whether the user has selected or actuated the loop button 402. In addition to actuating a previous or next measure button 404, 406, according to exemplary embodiments of the present invention, a user may similarly be capable of actuating a loop button 402 of the user interface in order to cause, for example, the current measure of the music file (i.e., the measure of the music file that is in the process of being played when the loop button 402 is actuated) to be repeated. If it is determined, in Step 103h, that the user has selected or actuated the loop button 402, the music player may skip to the beginning of the current measure (Step 103i), and then return again to Step 103a where the music file continues playing until the user actuates the loop or previous/next measure button 402, 404, 406.

In one exemplary embodiment, a user may actuate the loop button 402 once in order to place the music player into loop mode, causing the music player to continue looping the current measure until the user again actuates the loop button 402. In another exemplary embodiment, the user may be required to continuously actuate (e.g., hold down) the loop button 402 for the length of time for which he or she desires to loop the current measure. In yet another exemplary embodiment, the user may hold down the loop button 402 for a period of time to indicate a number of measures he or she desires to loop. For example, the user may hold down, or otherwise actuate, the loop button 402 throughout the duration of two measures. Upon releasing the loop button 402, the music player may begin looping or repeating those two measures. In another alternative embodiment, a user may be able to actuate the loop button 402 for a certain number of beats in order to indicate the number of measures to be repeated or looped. To illustrate, a user may actuate the loop button 402 for three beats of a particular measure, this may be taken by the music player as an indication that the user desires to loop or repeat three measures, beginning with the current measure. As one of ordinary skill in the art will recognize, the foregoing is not limited to looping measures. In contrast, a user may similarly actuate the loop button 402 in order to repeat one or more pulses of a smaller (e.g., beats) or larger (e.g., segments) time scale or level as the measure.

Returning to Step 103h, if it is determined that the user has not actuated the loop button 402, the process will continue to Step 103j where it is determined whether the music player has reached the end of the music file. If so, the process ends (i.e., the music player will stop). (Step 103k). If not, the process returns to Step 103a, where the music file continues to be played as the original music file, until it is determined that the user wishes to either loop a particular beat, measure or segment or skip ahead or back one or more beats, measures or segments.

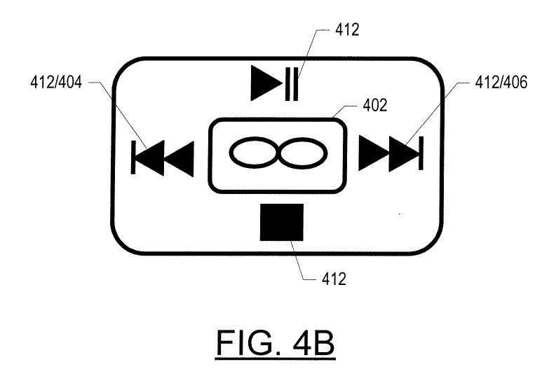

In addition to the foregoing, in one exemplary embodiment, when a jump is made from a location in the music file to some other location (e.g., from the end of the first beat of a measure to the beginning of the next measure) known methods of crossfading may be applied to make the transition more pleasing for the listener. FIG. 5 shows an example of how this kind of transition can be done using crossfading. In particular, FIG. 5 shows two portions of the currently playing music file 501 and 502. A jump is made at time t after the beat B1 of the first portion of the audio file 501 to the beginning of the measure M3 of the second portion of the audio file 502. First, the volume 504 of the second audio portion 502 is in minimum, so that the listener may only hear the first audio portion 501. When the player is getting closer to the end of the beat B1 (the time is at t-t1-t2, where t is the time when the beat B1 ends and when the jump is made), it starts to increase the volume 504 of the second audio portion; that is, the player starts to fade the second audio portion in. The samples of both the audio portions are multiplied with the volume and mixed. After t1, the player has faded the second audio portion in and both audio portions are fully heard over time t2. At t, the player has reached the end of the beat B1 and starts to decrease the volume 503 of the first audio portion; that is, the player starts to fade out the first audio portion. After t3, the player has faded the first audio portion completely out and the user may only hear the second audio portion. Typical durations for t1, t2, and t3 may be t1=10 ms, t2=10 ms, and t3=150 ms, for example. The crossfading example described above is provided for illustrative purposes only, and other crossfading methods known to those skilled in the art might be used as well.

The foregoing provides just one manner in which a user may vary the beats, measures or segments of a music file in real time (i.e., as the music file is being played) in accordance with exemplary embodiments of the present invention. In general, the user can create any combination of beats, measures or segments using the techniques discussed above. An advantage of exemplary embodiments is that the user is able to do so using an easy to understand interface that enables the user to skip between and repeat beats, measures and segments of a music file in a manner that does not disrupt the continuity of the music file.

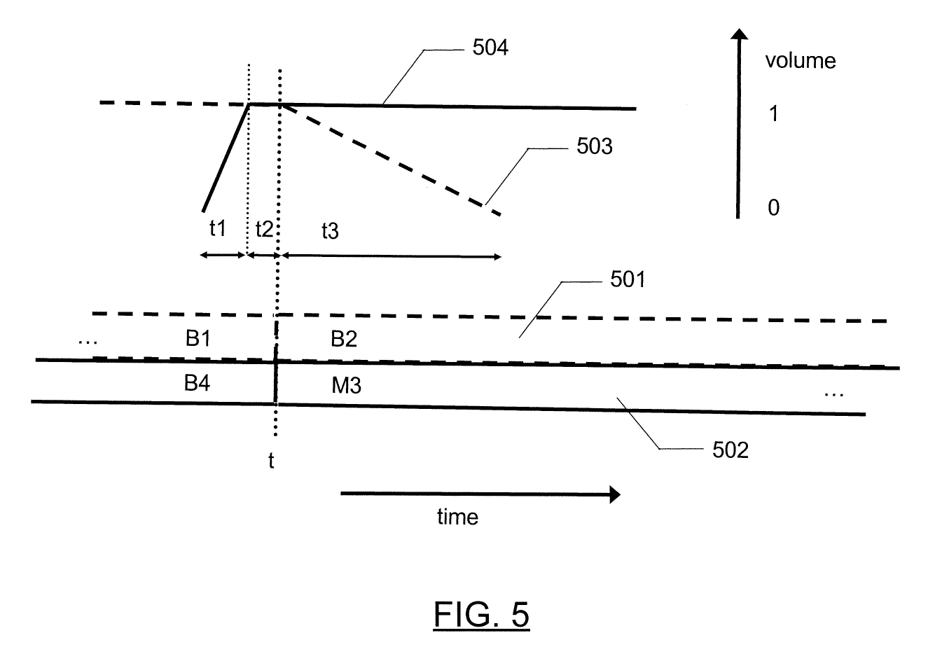

Returning now to FIG. 1, the next step in the overall process is to create a variation metadata file associated with the variation created by the user. (Step 104). In particular, according to exemplary embodiments of the present invention, a user is able to store information in the form of metadata regarding, for example, the playback order of beats, measures, and segments, the number of loops of each measure or segment made by the user, the location of jumps made by the user, and the like. The variation metadata file created is subsequently capable of being stored and transmitted separately from the original music file and ultimately used to recreate the variation created in Step 103. FIG. 6 further illustrates the steps which may be taken in order to perform this step of the overall process in accordance with exemplary embodiments of the present invention.

As shown, the variation metadata file is created by first recording the beats, measures and segments played by the user while creating the variation or remix. (Step 104a). In one exemplary embodiment, in order for Step 104a to be performed, the user must first actuate a record button on the user interface (not shown) in order to instruct the music player to begin creating the variation metadata file. Alternatively, the beat, measure and segment information may automatically be recorded any time a user begins playing a music file. In the latter instance, at the end of the process, the user may be given the option of deleting the variation metadata file created, or saving it to a particular location. In yet another alternative embodiment, the recording of the variation metadata may be initiated once the user first presses the loop button 402, or once he or she presses either the previous or next measure buttons 404, 406.

Regardless of how the recording is initiated, in Step 104b, an index associated with each beat, measure or segment recorded may then be determined by, for example, consulting the rhythm metadata file associated with the music file. Finally, the indices are combined, in Step 104c, into the variation metadata file in such a manner that the order and combination of indices reflects, for example, the order in which the beats, measures and segments were played, a number of times various beats, measures or segments were repeated or looped, and the like.

The following Table 3 provides several examples of variation metadata files, which may be created in accordance with exemplary embodiments of the present invention, as well as a description of each corresponding variation or remix.

TABLE 3

| Variation | |
|---|---|
| Metadata File | |
| <optional | |
| ID of the | |
| musical work> | Description of Corresponding Variation |
| M1-4L4 | loop first four measures four times |
| M5 | play fifth measure |
| M6 | play sixth measure |
| M7L3 | loop seventh measure three times |
| | end |
| M5L4.2 | loop the fifth measure 4.2 times (i.e., play the |
| | fifth measure four times and at the fifth |
| | playback, play only the first two beats of the |
| | fifth measure) |
| | end |
| M1-27 | play measures 1-27 |
| M28L4 | loop the 28^{th} measure four times |
| M29-E | play from the 29^{th} measure until the end of the song |
| | end |
| M3L4 | loop third measure four times |
| M16L6 | loop 16^{th} measure six times |
| | end |
| S1L2 | loop the first segment two times |
| | end |
| C2 | play second chorus once |
| | end |
| M1.2-L2 | start at the second beat of the first measure |
| | loop from the second beat of the first measure |
| | to the end of the measure twice |
| | end |
| M-3.2L4 | loop first two beats of third measure four times |
| | end |
| M1.1L5 | loop first beat of first measure five times |
| | end |

As shown, each variation metadata file may comprise a relatively small amount of data, thus enabling a user to store dozens of variations for an original musical work with minimal storage requirements. In addition, the variation metadata files may be in the form of simple text, enabling the files to be transmitted as text messages (e.g., E-mails, Short Message Service (SMS) messages, Instant Messages (IMs), or the like), and edited using, for example, a simple text editor operating on the user's device. This would enable a user, for example, to change a variation of the music file that he or she has created without having to replay the music file or use the above-described user interfaces to loop and/or skip beats, measures or segments of a currently playing music file. The user can simply add, remove or change the combination of indices of the variation metadata file in order to affect the change to the created variation.

In addition to the foregoing, as shown in the first exemplary variation metadata file of Table 3, an identifier associated with the original work may also be included in the variation metadata file. In one exemplary embodiment, the identifier may comprise a Uniform Resource Identifier (URI) or Locator (URL), the title of the original music file, or a similar identifier, which can later be used by the creator of the variation, or a party to whom he or she transmits the variation metadata file, to identify the original musical work. In one exemplary embodiment, the identifier may comprise an acoustic fingerprint, based on which the music player can search the device and/or a music service in order to locate the musical work. However, in this exemplary embodiment, because the acoustic fingerprint cannot be represented in a textual format (since it is typically binary), the identification may be communicated separately from the variation metadata file (e.g., as an attachment to the E-mail including the variation metadata file in the body of the email).

Returning again to FIG. 1, as noted above, once the variation metadata file has been created, the file is capable of being stored (Step 105) and transmitted (Step 106) separately from the original music file. In particular, a user may transmit the variation metadata file to a friend or family member with whom he or she would like to share the variation or remix created.

The friend or family member receives the variation metadata file, in Step 107, for example, as an E-mail, SMS message or IM. Thereafter, assuming the recipient already possesses the original musical work or is capable of locating and downloading it (e.g., via an online retail supplier), the recipient first accesses the rhythm metadata file associated with the original music file. (Step 108). As noted above, the recipient's device may have created the rhythm metadata file after downloading or receiving the music file. Alternatively, the source of the music file may have provided the rhythm metadata file to the recipient in conjunction with the actual music file. Alternatively, the recipient of the variation metadata file may request the rhythm metadata file from the party who sent the variation metadata file. Regardless of how the rhythm metadata file has been obtained, once the user has access to the rhythm metadata file, he or she is then able to recreate the variation of the music file, in Step 109, using the variation metadata file received in conjunction with the rhythm metadata file.

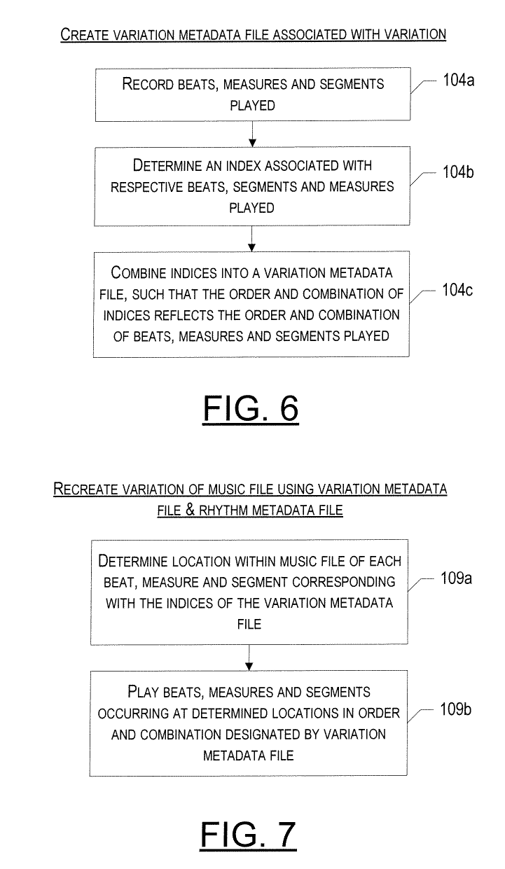

In particular, reference is made to FIG. 7, which illustrates the steps which may be performed in accordance with exemplary embodiments of the present invention in order to recreate the variation or remix of the music file. As shown, the first step is to determine a location within the music file associated with each beat, measure or segment corresponding with the indices of the variation metadata file. (Step 109a). This step may be performed by cross-referencing the indices of the variation metadata file with the indices and location information of the rhythm metadata file. The music player can then play the beats, measures and segments occurring at the determined locations in the order and combination designated by the variation metadata file. (Step 109b).

Overall System and Mobile Device:

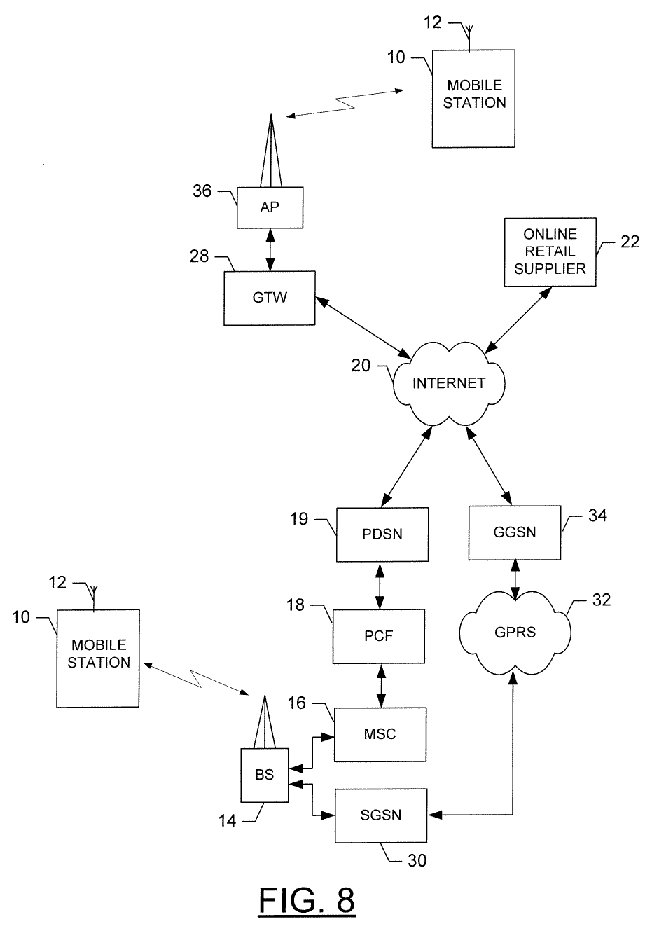

Referring to FIG. 8, an illustration of one type of system that would benefit from exemplary embodiments of the present invention is provided. As shown in FIG. 8, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include one or more processing elements (e.g., a server) associated with an online retail source or supplier of music files 22. As discussed above, the online retail supplier 22 may provide one or more music files, and their corresponding rhythm metadata files, for downloading by a user to his or her mobile device. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 8) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., Online Retail Supplier 22) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 8, in addition to or in lieu of coupling the mobile stations 10 to one or more processing elements (e.g., a server associated with an Online Retail Supplier 22) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

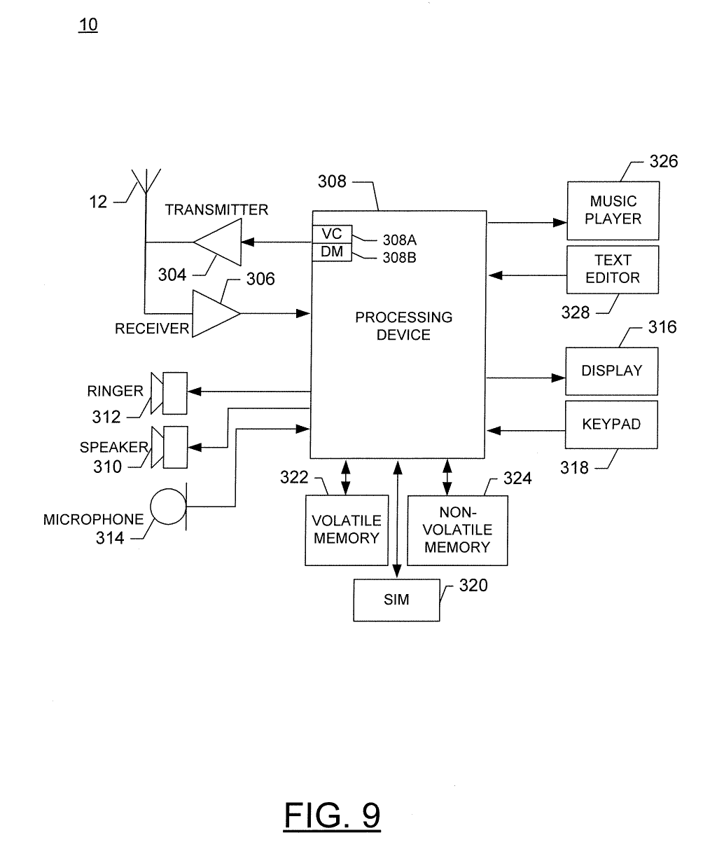

Reference is now made to FIG. 9, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 9, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideb and (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. In addition, the keypad 318 of exemplary embodiments of the present invention may further include one or more keys capable of being used to vary the beats, measures or segments of a currently playing music file, and may resemble those illustrated in FIG. 4A or 4B and discussed above in connection with those figures and with Step 103 of FIG. 1. Alternatively, as also noted above, the display 316 of the mobile station 10 may comprise a touch display, wherein the icons illustrated in FIG. 4A or 4B are capable of being displayed on the display screen 316 and subsequently selected by the user by touching the display 316 in the vicinity of those icons or representations, for example with a pointer or stylus.

The mobile station 10 may further include a music player 326 capable of playing a music file and performing a plurality of commands with respect to the currently playing music file (e.g., pause, stop, fast forward, rewind, skip track, etc.). In particular, the music player 326 may comprise various means, including entirely hardware, entirely software, or any combination of software and hardware, for performing one or more functions in accordance with exemplary embodiments. For example, as discussed above, the music player 326 may comprise various means for skipping forward or back a beat, measure or segment in a music file, or repeating a beat, measure or segment, upon receiving instructions to do so from the user via, for example, the user interface of FIG. 4A or 4B.

The mobile station 10 may further include a text editor 328, likewise comprising various means, including entirely hardware, entirely software, or any combination of hardware and software, for enabling a user to edit a variation metadata file that has been created, for example, in the method discussed above.

Although not shown, the mobile station may also include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory can also store content. For example, they memory may store one or more rhythm metadata files created, for example, in the manner discussed above in relation to FIG. 2, and corresponding with a respective one or more music files, which also may be stored by the memory. The memory may further store one or more variation metadata files created, for example, in the manner discussed above in relation to FIG. 6. As noted above, the memory may store several variation metadata files for each musical work or file similarly stored (i.e., the user may create multiple variations for the same musical work).

In addition, the memory may store computer program code for an application and other computer programs. For example, in one embodiment of the present invention, the memory may store computer program code for performing any one or more of the steps discussed above with reference to FIGS. 1, 2, 3, 5 and 6. In particular, the memory may store computer program code for creating either or both of a rhythm or variation metadata file, and/or recreating a variation of a music file using the corresponding variation metadata file in conjunction with the rhythm metadata file associated with the original musical work.

The method, device, system and apparatus of exemplary embodiments of the present invention are primarily described in conjunction with mobile communications applications. It should be understood, however, that the method, device, system and apparatus of embodiments of the present invention can be utilized in conjunction with a variety of other applications, both in the mobile communications industries and outside of the mobile communications industries. For example, the method, device, system and apparatus of exemplary embodiments of the present invention can be utilized in conjunction with wireline and/or wireless network (e.g., Internet) applications.

Conclusion:

As described above and as will be appreciated by one skilled in the art, embodiments of the present invention may be configured as a method, device, system and apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of creating and sharing one or more variations of a music file, said method comprising:
enabling a user to create a variation of a music file, wherein the music file comprises one or more segments, respective segments further comprise one or more measures and respective measures further comprise one or more beats, and wherein the variation comprises a combination of at least one beat, measure or segment of the music file; and
creating a variation metadata file comprising an index associated with respective at least one beat, measure or segment of the combination and indicating an order in which the at least one beat, measure or segment are combined, wherein the variation metadata file is capable of being stored and transmitted separately from the music file.

2. The method of claim 1 further comprising:
analyzing the music file to determine a location within the music file corresponding with respective beats, measures and segments of the music file;
assigning an index to respective beats, measures and segments; and
creating a rhythm metadata file associated with the music file, wherein the rhythm metadata file comprises a combination of the assigned index and an indication of the determined location within the music file corresponding with respective beats, measures and segments of the music file.

3. The method of claim 2, wherein the indication of the determined location within the music file corresponding with respective beats, measures and segments comprises some combination of a time associated with a beginning of respective beats, measures and segments, a time associated with an end of respective beats, measures and segments, a number of beats per measure, and a number of measures per segment.

4. The method of claim 2 further comprising:
playing the music file, wherein enabling a user to create a variation of the music file comprises enabling the user to vary at least one of the beats, measures or segments of the music file currently playing, such that playing the music file comprises playing the music file as varied by the user.

5. The method of claim 4, wherein creating a variation metadata file comprises:
recording the at least one beat, measure or segment played;
determining an index associated with respective at least one beat, measure or segment recorded, based at least in part on the rhythm metadata file associated with the music file; and
combining the at least one index into the variation metadata file, such that the combination of indices reflects the at least one beat, measure or segment played and an order in which the at least one beat, measure or segment were played.

6. The method of claim 2, wherein the variation metadata file is capable of being used to recreate the variation of the music file by accessing the rhythm metadata file associated with the music file to determine a location within the music file corresponding with respective at least one beat, measure or segment associated with the at least one index of the variation metadata file.

7. The method of claim 1, wherein the variation metadata file comprises a text file capable of being edited.

8. A user interface for creating one or more variations of a music file, said user interface comprising:
a plurality of input elements, wherein respective input elements are configured to receive at least one of a plurality of commands for varying a music file, wherein said music file comprises one or more segments, respective segments comprise one or more measures, and respective measures comprise one or more beats; and
an output element configured to output a variation of the music file in response to the at least one command, such that the variation comprises one or more beats, measures and segments of the music file varied based at least in part on a location within the music file associated with at least one beat, measure or segment of the music file.

9. The user interface of claim 8, wherein the location within the music file associated with at least one beat measure or segment is determined based at least in part on a rhythm metadata file associated with the music file, said rhythm metadata file comprising a combination of an index and a location within the music file associated with respective beats, measures and segments of the music file.

10. The user interface of claim 8, wherein at least one of the plurality of input elements comprises a repeat element configured to receive a command to repeat at least one beat, measure or segment of the music file, and wherein the output element is configured to repeat the at least one beat, measure or segment based at least in part on a location associated with a beginning of the at least one beat, measure or segment.

11. The user interface of claim 8, wherein at least one of the plurality of input elements comprises a skip forward element configured to receive a command to skip forward at least one beat, measure or segment of the music file, and wherein the output element is configured to output a current beat of the music file prior to outputting a next beat, measure or segment, as determined based at least in part on a location within the music file associated with a beginning of the next beat, measure or segment.

12. The user interface of claim 8, wherein at least one of the plurality of input elements comprises a skip back element configured to receive a command to skip back at least one beat, measure or segment of the music file, and wherein the output element is configured to output a current beat of the music file prior to outputting a previous beat, measure or segment, as determined based at least in part on a location within the music file associated with a beginning of the previous beat, measure or segment.

13. The user interface of claim 8, wherein the plurality of input elements comprise a plurality of keys capable of being actuated.

14. An apparatus for creating and sharing one or more variations of a music file, said apparatus comprising:
a processing element configured to:
record a combination of one or more beats, measures and segments of a music file in an order and a combination in which the beats, measures and segments are currently being played;
determine an index associated with respective beats, measures and segments of the combination; and
create a variation metadata file comprising the associated indices determined, wherein the indices are combined in the order and combination in which the corresponding beats, measures and segments were played.

15. The apparatus of claim 14, wherein the processing element is further configured, upon execution, to:
analyze a music file comprising one or more segments, respective segments further comprising one or more measures, and respective measures further comprising one or more beats, in order to determine a location within the music file corresponding with respective beats, measures and segments;
assign an index to respective beats, measures and segments of the music file; and
create a rhythm metadata file associated with the music file, wherein the rhythm metadata file comprises a combination of the assigned index and an indication of the determined location within the music file corresponding with respective beats, measures and segments of the music file.

16. The apparatus of claim 15, wherein determining an index associated with respective beats, measures and segments of the combination comprises accessing the rhythm metadata file to determine the associated indices.

17. An apparatus for recreating one or more variations of a music file, said apparatus comprising:
a processing element configured to:
receive a variation metadata file comprising one or more indices associated with a respective one or more beats, measures or segments of a variation of a music file;
access a rhythm metadata file comprising a combination of one or more indices associated with a respective one or more beats, measures and segments of the music file and an indication of a location within the music file associated with respective beats, measures and segments of the music file;
determine, based at least in part on the variation metadata file and the rhythm metadata file, a location within the music file corresponding with respective beats, measures and segments of the variation metadata file.

18. The apparatus of claim 17, wherein the processing element is further configured, upon execution, to:
cause the beats, measures and segments at the determined locations to be played in the order and the combination in which the indices are combined in the variation metadata file.

19. A device capable of creating and sharing one or more variations of a music file, said device comprising:
a processor;
a user interface configured to enable a user to create a variation of a music file, wherein the music file comprises one or more segments, respective segments comprise one or more measures, and respective measures comprise one or more beats, and wherein the variation comprises a combination of at least one beat, measure or segment of the music file; and
a memory in communication with the processor, said memory storing an application executable by the processor, wherein the application is configured, upon execution, to create a variation metadata file comprising an index associated with respective at least one beat, measure or segment of the combination and indicating an order in which the at least one beat, measure or segment are combined, wherein the variation metadata file is capable of being stored and transmitted separately from the music file and further of being used to recreate the variation of the music file.

20. The device of claim 19, wherein the application is further configured, upon execution, to:
analyze the music file to determine a location within the music file corresponding with respective beats, measures and segments of the music file;
assign an index to respective beats, measures and segments; and
create a rhythm metadata file associated with the music file, wherein the rhythm metadata file comprises a combination of the assigned index and an indication of the determined location within the music file corresponding with respective beats, measures and segments of the music file.

21. The device of claim 20 further comprising:
a music player in communication with the processor and configured to play the music file, wherein enabling a user to create a variation of a music file comprises enabling the user to vary at least one beat, measure or segment of the music file currently playing, such that playing the music file comprises playing the music file as varied by the user.

22. The device of claim 21, wherein the user interface comprises a plurality of input elements, wherein respective input elements are configured to receive at least one of a plurality of commands for varying at least one beat, measure or segment of the music file.

23. The device of claim 22, wherein at least one of the plurality of input elements comprises a repeat element configured to receive a command to repeat at least one of the beats, measures or segments, and wherein the variation metadata file further comprises an indication of a number of times the at least one beat, measure or segment is repeated in response to the command.

24. The device of claim 22, wherein at least one of the plurality of input elements comprises a skip element configured to receive a command to skip at least one of the beats, measures or segments.

25. The device of claim 21, wherein in order to create a variation metadata file, said application is further configured, upon execution, to:
record the at least one beat, measure or segment played by the music player;
determine an index associated with respective at least one beat, measure or segment recorded, based at least in part on the rhythm metadata file associated with the music file; and
combine the at least one index into the variation metadata file, such that the combination of indices reflects the at least one beat, measure or segment played and an order in which the at least one beat, measure or segment were played.

26. The device of claim 20, wherein the application is further configured to recreate the variation of the music file by accessing the rhythm metadata file associated with the music file to determine a location within the music file corresponding with respective at least one beat, measure or segment associated with the at least one index of the variation metadata file.

27. The device of claim 19, wherein the variation metadata file comprises a text file, said device further comprising:
a text editor configured to enable a user to edit the variation metadata file.

28. A system for creating and sharing one or more variations of a music file, said system comprising:
a first device configured to:
enable a user to create a variation of a music file, said music file comprising one or more segments, respective segments further comprising one or more measures, and respective measures further comprising one or more beats, said variation comprising a combination of at least one of the beats, measures or segments of the music file
create a variation metadata file comprising an index associated with respective at least one beat, measure or segment of the combination and an indication of an order in which the at least one beat, measure or segment are combined, and
separately transmit the variation metadata file; and
a second device configured to receive the variation metadata file and to recreate the variation of the music file using the variation metadata file received.

29. The system of claim 28, wherein respective first and second devices are further configured to:
analyze the music file to determine a location within the music file corresponding with respective beats, measures and segments of the music file;
assign an index to respective beats, measures and segments; and
create a rhythm metadata file associated with the music file, wherein the rhythm metadata file comprises a combination of the assigned index and an indication of the determined location within the music file corresponding with respective beats, measures and segments of the music file.

30. The system of claim 29, wherein the first device comprises a music player configured to play the music file, and wherein in order to enable a user to create a variation of the music file, the first device further comprises a user interface configured to enable the user to vary at least one of the beats, measures or segments of the music file currently being played by the music player, such that playing the music file comprises playing the music file as varied by the user.

31. The system of claim 30, wherein in order to enable a user to create a variation of the music file, the first device is further configured to:
record the at least one beat, measure or segment played by the music player;
determine an index associated with respective at least one beat, measure or segment recorded, based at least in part on the rhythm metadata file associated with the music file; and
combine the at least one index into the variation metadata file, such that the combination of indices reflects the at least one beat, measure or segment played and an order in which the at least one beat, measure or segment were played.

32. The system of claim 29, wherein in order to recreate the variation of the music file, the second device is further configured to:
access the rhythm metadata file associated with the music file;
determine a location within the music file corresponding with respective at least one beat, measure or segment associated with the at least one index of the variation metadata file; and
play the at least one beat, measure or segment at the one or more determined locations in the order indicated by the variation metadata file.

33. A computer program product for creating and sharing one or more variations of a music file, wherein the computer program product comprises at least one computer-readable storage medium having computer-readable program code portions stored therein, said computer-readable program code portions comprising:
a first executable portion for enabling a user to create a variation of the music file, wherein the music file comprises one or more segments, respective segments further comprise one or more measures and respective measures further comprise one or more beats, and wherein the variation comprises a combination of at least one beat, measure or segment of the music file; and
a second executable portion for creating a variation metadata file comprising an index associated with respective at least one beat, measure or segment of the combination and indicating an order in which the at least one beat, measure or segment are combined, wherein the variation metadata file is capable of being stored and transmitted separately from the music file and further of being used to recreate the variation of the music file.

34. The computer program product of claim 33, wherein the computer-readable program code portions further comprise:
a third executable portion for analyzing the music file to determine a location within the music file corresponding with respective beats, measures and segments of the music file;
a fourth executable portion for assigning an index to respective beats, measures and segments; and
a fifth executable portion for creating a rhythm metadata file associated with the music file, wherein the rhythm metadata file comprises a combination of the assigned index and an indication of the determined location within the music file corresponding with respective beats, measures and segments of the music file.

35. The computer program product of claim 34, wherein the computer-readable program code portions further comprise:
a sixth executable portion for playing the music file, wherein enabling a user to create a variation of the music file comprises enabling the user to vary at least one of the beats, measures or segments of the music file currently playing, such that playing the music file comprises playing the music file as varied by the user.

36. The computer program product of claim 35, wherein in order to create a variation metadata file, the computer-readable program code portions further comprise:
a seventh executable portion for recording the at least one beat, measure or segment played;
an eighth executable portion for determining an index associated with respective at least one beat, measure or segment recorded, based at least in part on the rhythm metadata file associated with the music file; and
a ninth executable portion for combining the at least one index into the variation metadata file, such that the combination of indices reflects the at least one beat, measure or segment played and an order in which the at least one beat, measure or segment were played.

37. The computer program product of claim 34, wherein the computer-readable program code portions further comprise:
a sixth executable portion for recreating the variation of the music file by accessing the rhythm metadata file associated with the music file to determine a location within the music file corresponding with respective at least one beat, measure or segment associated with the at least one index of the variation metadata file.

38. The computer program product of claim 35, wherein enabling a user to vary at least one of the beats, measures or segments of the music file comprises enabling a user to at least one of repeat or skip at least one of the beats, measures or segments, and wherein the variation metadata file further comprises an indication of a number of times the at least one beat, measure or segment is repeated.
